(19) United States
(12) Patent Application Publication
(10) Pub. No.: US 2024/0194955 A1
(43) Pub. Date: Jun. 13, 2024

(54) ELECTROLYTES OF RECHARGEABLE LITHIUM-SULFUR BATTERIES AND LITHIUM-SULFUR BATTERIES INCLUDING THE SAME

(71) Applicant: Giner, Inc., Newton, MA (US)

(72) Inventors: Castro Laicer, Action, MA (US); Pavithra Murugavel Shanthi, Natick, MA (US); Katherine Harrison, Arlington, MA (US)

(21) Appl. No.: 18/286,863

(22) PCT Filed: Apr. 15, 2022
(86) PCT No.: PCT/US22/24976

§ 371 Date: Oct. 13, 2023

Related U.S. Application Data
(60) Provisional application No. 63/175,343, filed on Apr. 15, 2021.

(51) Int. Cl. H01M 10/42; H01M 10/052; H01M 10/0565; H01M 10/0567; H01M 10/0569

(52) U.S. Cl. CPC H01M 10/4235; H01M 10/052; H01M 10/0565; H01M 10/0567; H01M 10/0569; H01M 2300/0037; H01M 2300/0085

(57) ABSTRACT

An electrolyte includes a lithium (Li) salt, a fluorinated solvent, a 1,3-dioxaolane (DOL) solvent, a 1,2-dimethyoxyethane (DME) solvent, a lithium polysulfide (LiPS), and a lithium nitrate (LiNO₃). Lithium sulfur electrochemical devices, such as lithium electrochemical cells and lithium-sulfur batteries, such as lithium-sulfur rechargeable (secondary) batteries include an electrolyte that includes a lithium (Li) salt, a fluorinated solvent, a 1,3-dioxaolane (DOL) solvent, a 1,2-dimethyoxyethane (DME) solvent, a lithium polysulfide (LiPS), and a lithium nitrate (LiNO₃).

### RELATED APPLICATION

This application claims the benefit of U.S. Provisional Application No. 63/175,343, filed on 15 Apr. 2021, the relevant teachings of which are incorporated herein by reference in their entirety.

### GOVERNMENT SUPPORT

This invention was made with government support under NASA SBIR Phase I Contract No. 80NSSC20C0535 awarded by the National Aeronautics and Space Administration, Shared Services Center (NSSC). The government has certain rights in the invention.

### FIELD OF INVENTION

This invention relates to novel electrolytes for use in lithium-sulfur batteries (LSBs) and to lithium-sulfur batteries that employ electrolytes of the invention.

### BACKGROUND

The lithium-sulfur battery (LSB) is one of the most promising technologies for next-generation power systems because of its high theoretical gravimetric energy density of 2500 Wh/kg,¹⁻² which is up to 5 times higher than the theoretical value of state-of-the-art (SOA) commercial lithium-ion battery (LIB) cells.³⁴ The higher energy density LSB enables more energy for an equivalent battery pack, or a lighter pack with equivalent energy delivered. LSBs rely on a non-insertion charge-discharge mechanism which proceeds through a series of lithium polysulfide (LiPS) intermediates. Sulfur is advantageous for battery cathode applications because it is a low-cost and earth-abundant material with an extremely high theoretical capacity of 1675 mAh/g.⁵ Future LSB cells are estimated to deliver a practical gravimetric energy density of 400 to 600 Wh/kg,⁶ which is still two- to three-fold higher than SOA LIB cells. However, despite its promise, several fundamental challenges limit commercial practical applications of LSBs. These obstacles include poor electrical conductivity of sulfur, dissolution of lithium polysulfides (LiPSs) in the electrolyte, large volume increase (80%) of the sulfur cathode after full lithiation to Li₂S, polysulfide shuttling between the cathode and anode, as well as dendrite formation and electrolyte decomposition at the lithium metal anode interface.

The standard state SOA Li—S electrolyte is one cause of chronically low cycle life in Li—S batteries. The dissolution of LiPS intermediates into the electrolyte and subsequent diffusion to the anode results in a polysulfide shuttle reaction. This reaction is parasitic, reducing efficiency, consuming electrolyte and lithium, resulting in an insulating product layer on the anode surface which inhibits Li transport and is therefore detrimental to cycle life performance. Lithium trifluoromethane sulfonyl imide (LiTFSI) used in standard LSB electrolytes is a weakly bound salt with a calculated ionic association energy, ΔG_{ion association}, of −58 KJ/mol Li⁺.⁷ This weak ionic interaction between Li⁺ and the TFSI⁻ salt anion leaves the Li⁺ cation more available to coordinate with polysulfide dianions (Sₓ²⁻), thus promoting formation of large clustered aggregates of Li₂S₄ which inhibit the kinetics of lithium polysulfide conversion reactions.⁷ Low temperature operation conditions also place unique performance challenges on LSBs.

Published work describes the use of fluorinated co-solvents (e.g., fluorinated-carbonates,⁸⁻⁹ fluorinated-ethers,¹⁰ and fluorinated-esters,¹⁰⁻¹⁴) to demonstrate low temperature performance of LIBs. Specifically, fluorinated ester co-solvents such as 2,2,2-trifluoroethyl butyrate (TFEB)¹³ and 2,2,2-trifluoroethyl propionate (TFEP)¹⁴ have been incorporated into multicomponent carbonate electrolytes to achieve enhanced LIB performance down to −60° C. for TFEB and −40° C. for TFEP. In another example, a fluorinated ether cosolvent, monoglycol bis(tetrafluoroethyl) ether, was added to ethyl carbonate (EC) to achieve favorable LIB cell performance down to −50° C. Fluorinated ether cosolvents have also been used in LSBs electrolytes to mitigate polysulfide dissolution at room temperature conditions. For example, several fluorinated ethers including bis(2,2,2-trifluoroethyl) ether (BTFE),¹⁵⁻¹⁶ 1,1,2,2-tetrafluoroethyl-2,2,3,3-tetrafluoropropyl ether (TTE),¹⁷⁻¹⁹ and ethyl-1,1,2,2-tetrafluoroethyl ether (TTFE),²⁰ have shown improvements in capacity retention, coulombic efficiency, and self-discharge performance in LSB cells compared to the baseline 1,3-dioxolane/dimethoxyethane (DOL/DME) electrolyte.²¹⁻²²

In addition, to the choice of salt and solvent system, a range of additives can be utilized to control polysulfide dissolution. The solubility of lithium polysulfide will be affected by the concentration of polysulfide ions already present in the electrolyte by the common ion effect. If the concentration of the polysulfide in the electrolyte is significantly larger than the solubility of polysulfide, the electrolyte will have reduced polysulfide dissolution from the cathode. Therefore, when a LiPS pre-dissolved electrolyte is used, the solubility of lithium polysulfide will naturally be reduced significantly.

Therefore, a need exists to overcome or minimize the above-referenced problems.

### SUMMARY

In one embodiment, the invention is directed towards an electrolyte that includes a lithium (Li) salt, a fluorinated solvent, a 1,3-dioxaolane (DOL) solvent, a 1,2-dimethyoxyethane (DME) solvent, a lithium polysulfide (LiPS), and a lithium nitrate (LiNO₃).

In another embodiment, the invention is directed to a lithium-sulfur electrochemical device that includes a cathode, an anode, a separator between the cathode and the anode, and at least one of a liquid electrolyte and a polymer gel electrolyte, wherein the electrolyte includes a lithium (Li) salt, a fluorinated solvent, a 1,3-dioxaolane (DOL) solvent, a 1,2-dimethyoxyethane (DME) solvent, a lithium polysulfide (LiPS), and a lithium nitrate (LiNO₃).

This invention has many advantages, such as mitigating generation of lithium polysulfides. Furthermore, this invention improves the operation of lithium sulfur batteries at low temperature conditions. These advantages enhance the cycle life performance of lithium sulfur batteries.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic representation of a suitable equivalent circuit used to calculate lithium ion conductivity known in the art.

FIGS. 2A through 2D are Electrochemical Impedance Spectroscopy (EIS) Nyquist plots of 1M LiCF₃SO₃+0.3M LiNO₃ in DOL:DME (50:50 vol %) with 1,1,2,2-tetrafluoroethyl 2,2,2-trifluoroethyl ether (TFETFEE) additive and an artificial solid electrolyte interphase (ASEI) protected Li anode of the invention, at (FIG. 2A) room temperature (RT), (FIG. 2B) −20° C., (FIG. 2C) −40° C., using a (FIG. 2D) equivalent circuit known in the art suitable for use to fit the experimental data of FIGS. 2A through 2C.

FIG. 3A is a cyclic voltammogram (CV) plot of 1M LiCF₃SO₃+0.3M LiNO₃ in DOL:DME (50:50 vol %) of the invention without an ASEI protected Li anode.

FIG. 3B is a cyclic voltammogram (CV) plot of 1M LiCF₃SO₃+0.3M LiNO₃ in DOL:DME (50:50 vol %) of the invention with an ASEI protected Li anode.

FIG. 4A is a cyclic voltammogram of a baseline electrolyte of the prior art.

FIG. 4B is a cyclic voltammogram of 1M LiCF₃SO₃+0.3M LiNO₃ in DOL:DME (50:50 vol %) electrolyte of the invention.

FIG. 5A is a cyclic voltammogram of a baseline (i.e. prior art) electrolyte of the prior art (1M LiTFSI+0.3M LiNO₃ in DOL:DME (50:50 vol %).

FIG. 5B is a charge-discharge profile of the baseline (i.e. prior art) electrolyte of the prior art (1M LiTFSI+0.3M LiNO₃ in DOL:DME (50:50 vol %).

FIG. 6A is a CV plot of 1M LiCF₃SO₃+0.3M LiNO₃ in DOL:DME (50:50 vol %) of an electrolyte of the invention.

FIG. 6B is a CV plot of 1M LiCF₃SO₃+0.3M LiNO₃ in DOL:DME (50:50 vol %) with 10 vol % TFETFEE cosolvent of an electrolyte of the invention.

FIG. 7A is a CV plot of 1M LiCF₃SO₃+0.3M LiNO₃ in DOL:DME (50:50 vol %) with TFETFEE cosolvent of an electrolyte of the invention.

FIG. 7B is a CV plot 1M LiCF₃SO₃+0.3M LiNO₃ in DOL:DME (50:50 vol %) with TFETFEE cosolvent of an electrolyte of the invention, in addition to an ASEI Li anode.

FIG. 8A is a self-extinguishing time (SET) test setup with electrolyte-soaked glass fiber disk ignited, as is known in the art.

FIG. 8B is an SET time histogram for electrolytes of the invention compared with a baseline electrolyte (1 M LiTFSI in DOL:DME) DME (50:50 vol %) and 0.3M LiNO₃) known in the art as shown in the first bar on the left. Electrolytes of the invention are shown in the second to fifth bar from left to right.

FIG. 9A is a histogram comparison of discharge capacity for baseline (i.e., known in the art) LiTFSI in DOL:DME+0.3M LiNO₃ (solid black bar) and 1M LiTFA in DOL:DME+0.3M LiNO₃ (striped bar with diagonal lines) electrolytes of the invention, at RT, −20° C., and −40° C.

FIG. 9B is a plot of voltage profiles for baseline (known) LiTFSI in DOL:DME+0.3M LiNO₃ (dashed lines) and 1M LiTFA in DOL:DME+0.3M LiNO₃ (solid lines) electrolytes of the invention, at RT, −20° C., and −40° C.

FIG. 10A is a plot of discharge curves for 1M LiCF₃SO₃ in DOL:DME+0.3M LiNO₃ of the invention at RT, −20° C., and −40° C.

FIG. 10B is a plot of discharge curves for 1M LiCF₃SO₃ in DOL:DME:TFETFEE+0.3M LiNO₃ of the invention at RT, −20° C., and −40° C.

FIG. 10C is a plot of discharge curves for 1M LiCF₃SO₃ in DOL:DME:ethyl-1,1,2,2-tetrafluoroethyl ether (ETFEE)+0.3M LiNO₃ of the invention at RT, −20° C., and −40° C.

FIG. 11A are plots of discharge capacity of LiCF₃SO₃ in DOL:DME+0.3M LiNO₃ of the invention with 0 to 50 vol. % TFETFEE.

FIG. 11B are plots of discharge capacity of LiCF₃SO₃ in DOL:DME+0.3M LiNO₃ of the invention with 0 to 50 vol. % ETFEE.

FIG. 12A is a plot of discharge capacity for baseline 1 M LiTFSI in DOL:DME+0.3M LiNO₃ (square symbols, known in the art), 1 M LiCF₃SO₃ in DOL:DME+0.3M LiNO₃ (circle symbols, electrolyte of the invention), and 1 M LiCF₃SO₃ in DOL:DME:TFETFEE+0.3M LiNO₃ (triangle symbols, electrolyte of the invention) as a function of cycle number at −20° C. (C/10 rate).

FIG. 12B is a plot of retention for baseline 1 M LiTFSI in DOL:DME+0.3M LiNO₃ (square symbols, known in the art), 1 M LiCF₃SO₃ in DOL:DME+0.3M LiNO₃ (circle symbols, electrolyte of the invention), and 1 M LiCF₃SO₃ in DOL:DME:TFETFEE+0.3M LiNO₃ (triangle symbols, electrolyte of the invention) as a function of cycle number at −20° C. (C/10 rate).

FIG. 13 are plots of results from long-term cycling of Li-sulfur batteries employing a baseline electrolyte (1 M LiTFSI in DOL:DME+0.3M LiNO₃) (square symbols, known in the art) and electrolytes of the invention at room temperature.

FIG. 14 are plots of Li-sulfur batteries employing electrolytes of the invention cycled at C/5 rate at RT, −20° C., and RT sequentially demonstrating capacity recovery after low temperature cycling.

FIG. 15A is a photograph of examples of Single Layer Pouch (SLP) cells of the invention.

FIG. 15B are plots of capacity delivered for SLPs and coin cells of FIG. 15A.

FIG. 16A is a plot of cycle life of the SLP cells of FIG. 15A at −20° C. with 1M LiCF₃SO₃+0.3 M LiNO₃ in DOL:DME:TFETFEE electrolyte of the invention.

FIG. 16B is a plot of voltage profiles of the SLP cells of FIG. 15A at −20° C. with 1M LiCF₃SO₃+0.3 M LiNO₃ in DOL:DME:TFETFEE electrolyte of the invention.

FIG. 17A is a postmortem picture of an Li anode of the invention exposed to three formation cycles in pouch cells with 1 M LiCF₃SO₃ and 0.3 M LiNO₃ in DOL:DME.

FIG. 17B is a postmortem picture of an Li anode of the invention exposed to three formation cycles in pouch cells with 1 M LiCF₃SO₃ and 0.3 M LiNO₃ in DOL:DME:TFETFEE.

FIG. 18A is a post-mortem analysis on cells of the invention cycled >50 times 1 M LiCF₃SO₃ and 0.3 M LiNO₃ in DOL:DME at −20° C.

FIG. 18B is a post-mortem analysis on cells of the invention cycled >50 times 1 M LiCF₃SO₃ and 0.3 M LiNO₃ in DOL:DME:TFETFEE at −20° C.

FIG. 18C is a post-mortem analysis on cells of the prior art cycled >50 times 1 M LiTFSI 0.3 M LiNO₃ in DOL:DME at RT.

FIG. 19 are Nyquist plots of polysulfide pre-dissolved electrolytes of the invention.

FIG. 20A are plots of electrochemical cycling testing of discharge capacity on the polysulfide pre-dissolved electrolytes (0.01-0.1M Li₂S₆) of the invention.

FIG. 20B are plots of electrochemical cycling testing of efficiency on the polysulfide pre-dissolved electrolytes (0.01-0.1M Li₂S₆) of the invention.

FIG. 20C are plots of electrochemical cycling testing of capacity retention on the polysulfide pre-dissolved electrolytes (0.01-0.1M Li₂S₆) of the invention.

### DETAILED DESCRIPTION

The invention generally is directed to electrolytes and rechargeable lithium-ion sulfur batteries that employ the electrolytes of the invention.

In one embodiment, the invention is directed to a fluid that includes a lithium (Li) salt, a fluorinated solvent, 1,3-dioxolane (DOL) solvent, 1,2-dimethoxyethane (DME) solvent, lithium polysulfide (LiPS), and lithium nitrate (LiNO₃).

In another embodiment, the invention is directed to an lithium-sulfur (Li—S) electrochemical device, such as an electrochemical cell or battery, such as a rechargeable battery, that includes a cathode, an anode, a separator between the cathode and the anode, and at least one of a liquid electrolyte and a polymer gel electrolyte in fluid communication with the cathode, the anode, and the separator, wherein the electrolyte includes a Li salt, a fluorinated solvent, 1,3-dioxolane (DOL) solvent, 1,2-dimethoxyethane (DME) solvent, lithium polysulfide (LiPS), and lithium nitrate (LiNO₃).

In one embodiment of the invention, the Li salt includes at least one member of the group consisting of lithium trifluoromethane sulfonate (LiCF₃SO₃), lithium trifluorosulfonyl methane (LiTFSM), lithium trifluoroacetate (LiTFA), and lithium bis(fluorosulfonyl)imide (LiFSI).

In a specific embodiment, the Li salt includes at least one member of the group consisting of lithium bis(trifluoromethanesulfonyl)imide (LiTFSI), lithium bis(trifluoromethylsulfonyl)imide (LiTFSI), and lithium trifluoromethanesulfonate (LiTf), lithium nonafluoro-1-butane sulfonate (Li(CF₃(CF₂)₃)SO₃), lithium acetate (LiCH₃SO₂), lithium bis(trifluoromethanesulfonyl)imide (Li(CF₃SO₂)₂N), lithium (fluorosulfonyl)-(trifluoromethanesulfonyl)imide (Li(FSO₂)(CF₃SO₂)N), lithium bis(pentafluoroethanesulfonyl)imide (Li(CF₃CF₂SO₂)₂N), lithium bis(nonafluorobutanesulfonyl)imide (Li(C₄F₉SO₂)₂N), lithium tris(trifluoromethanesulfonyl) methide (Li(CF₃SO₂)₃C, LiBF₄, LiBF₃(C₂F₅), LiB(C₂O₄)₂, LiB(C₆F₅)₄, LiPF₃(C₂F₅)₃, LiClO₄, LiPF₆, LiAsF₆, LiSbF₆, LiTaF₆, and LiNbF₆. In one such embodiment the Li salt is a blend that further includes at least one member of the group consisting of lithium trifluoromethane sulfonate (LiCF₃SO₃), lithium trifluorosulfonyl methane (LiTFSM), lithium trifluoroacetate (LiTFA), and lithium bis(fluorosulfonyl)imide (LiFSI).

In an embodiment of the electrochemical cell of the invention, the fluorinated solvent includes at least one member of the group consisting of 2,2,2-trifluoroethyl butyrate, 2,2,2-trifluoroethyl propionate, bis(2,2,2-trifluoroethyl) ether, 1,1,2,2-tetrafluoroethyl-2,2,3,3-tetrafluoropropyl ether, 1,1,2,2-tetrafluoroethyl 2,2,2-trifluoroethyl ether, ethyl-1,1,2,2-tetrafluoroethyl ether, 2,2,2-trifluoroethyl 1,1,2,2-tetrafluoroethyl ether, ethyl 1,1,2,2-tetrafluoroethyl ether, propyl 1,1,2,2-tetrafluoroethyl ether, fluoromethyl 1,1,1,3,3,3-hexafluoroisopropyl ether, ethyl 1,1,2,3,3,3-hexafluoropropyl ether, hexafluoroisopropyl methyl ether, methyl 1,1,2,2-tetrafluoroethyl ether, 1,1,2,3,3,3-hexafluoropropyl methyl ether, 1,1,2,2-tetrafluoroethyl 2,2,2-trifluoroethyl ether, ethyl 1,1,1,2,2,3,4,5,5,5-decafluoro-3-methoxy-4-(trifluoromethyl)pentane, difluoromethyl 2,2,3,3-tetrafluoropropyl ether, methyl nonafluorobutyl ether, ethyl nonafluorobutyl ether, 1H,1H,5H-octafluoropentyl 1,1,2,2-tetrafluoroethyl ether, 1,1,1,3,3,3-hexafluoro-2-methoxypropane, 1,1,1,3,3,3-hexafluoro-2-(fluoromethoxy)propane, bis(2,2,2-trifluoroethoxy)methane, bis((1,1,1,3,3,3-hexafluoropropan-2-yl)oxy)methane, 2,2,2-trifluoroethyl acetate, 1,1,1,3,3,3-hexafluoropropan-2-yl acetate, methyl (2,2,2-trifluoroethyl) carbonate, 1,1,1,3,3,3-hexafluoropropan-2-yl methyl carbonate, tris(2,2,2-trifluoroethyl) phosphate, tris(1,1,1,3,3,3-hexafluoropropan-2-yl) phosphate, tris(2,2,2-trifluoroethyl) phosphite, and bis(2,2,2-trifluoroethyl) sulfite.

In one embodiment, the lithium polysulfide of the invention has the chemical formula: Li₂Sₓ, wherein x is in a range of from 1 to 8.

In an embodiment of the invention, the lithium polysulfide of the invention has a concentration of 0 M to 8 M.

In a specific embodiment of the invention, the Li salt of the invention has a concentration of 0.01 M to 10 M.

In another embodiment of the invention, the lithium nitrate of the invention has a concentration of 0.01 M to 10 M.

In still another embodiment of the invention, the fluorinated solvent of the invention is 0% to 100% by volume of the electrolyte.

In one embodiment of the invention, the electrochemical cell is a lithium-sulfur battery.

In an embodiment of the invention, the anode of the electrochemical cell is selected from the group consisting of a silicon anode, a graphitic anode, a lithium metal anode, and a lithium alloy metal anode.

In yet another embodiment of the invention, at least one of the anode, the cathode, and the separator of the electrochemical cell of the invention is coated with an MXene-polymer composite material that includes a MXene component and a polymer component. In one such embodiment, the MXene polymer composite material is at least one of a multilayer film and a blend of MXene and polymer components of the MXene polymer composite material. In another embodiment, the MXene-polymer composite material is a multilayer film. In still another embodiment, the MXene-polymer composite material is a blend of the MXene and polymer components of the MXene polymer composite material.

In some embodiments, the electrochemical cells of the invention employ electrolytes comprising strongly bound Li salts dissolved in fluorinated ether-based cosolvents that enable low temperature performance. These electrolytes employ strongly bound Li salts^{7, 23} dissolved in a multi-component solvent blend which includes a low-viscosity and low-freezing point fluorinated ether^{15-20, 24-28} cosolvent blended with DOL and DME. This invention also encompasses the combination of these electrolytes paired with a Li anode protected with an artificial solid electrolyte interface (ASEI) to eliminate long chain polysulfide reactions.

In another aspect of this invention, pre-determined quantities of lithium polysulfide (LiPS) additive are dissolved in the electrolytes described above in addition to the Li-salt. Pre-dissolving LiPS in the electrolyte reduces the polysulfide dissolution at the cathode. The pre-dissolved LiPS in the electrolyte serves as a common ion (Sₓ⁻) and shifts the polysulfide dissolution reaction equilibrium towards polysulfide reduction into Li₂S. This common ion effect prevents the polysulfide dissolution by decreasing the solubility of polysulfides.

The electrolytes described in this invention include the standard LiTFSI salt as well as additional range of strongly bound Li salts, including but not limited to Lithium trifluoromethane sulfonate (LiCF₃SO₃), Lithium trifluorosulfonyl methane (LiTFSM) and Lithium trifluoroacetate (LiTFA). The electrolytes encompassed in this invention are comprised of solvent blends which incorporate fluorinated cosolvents and may also incorporate pre-dissolved polysulfide additives. Co-solvents include, but are not limited to fluorinated ester co-solvents such as 2,2,2-trifluoroethyl butyrate (TFEB)¹³ and 2,2,2-trifluoroethyl propionate (TFEP)¹⁴, fluorinated ethers including bis(2,2,2-trifluoroethyl) ether (BTFE),¹⁵⁻¹⁶ 1,1,2,2-tetrafluoroethyl-2,2,3,3-tetrafluoropropyl ether (TTE),¹⁷⁻¹⁹ and ethyl-1,1,2,2-tetrafluoroethyl ether (TTFE).^{20,21-22}

Electrolytes described in this invention have salt concentrations between 0.01 M and 10 M, including both dilute and high concentration, “salt-in-solvent” type electrolytes. In this invention, heat may be utilized to produce supersaturated electrolyte blends with very high salt concentrations. Choice of salt and solvent combinations can be tailored by those skilled in the art for specific applications, such as high rate, low temperature, or reduced flammability. The co-solvent may comprise between 0-100% of the solvent volume to achieve the desired characteristics.

In another aspect of the innovation, LiPS is pre-dissolved in the electrolyte to stop the polysulfides formed at the cathode from dissolving into the electrolyte. LiPS included in this invention include Li₂Sₓ (x=1-8). Pre-dissolved polysulfides included in this invention can be incorporated at concentrations between 0 M and 8 M.

In another aspect of this invention, the electrolytes may be combined with an artificial solid electrolyte interphase (ASEI) on the lithium metal anode. When combined with the an ASEI-protected Li metal anode, the disclosed electrolytes have demonstrated excellent chemical and electrochemical compatibility, low overpotential for the sulfur redox reaction and reduced polysulfide dissolution by providing a stable SEI. The anode used in this invention can also comprise a graphitic anode, silicon anode, or other anodes capable of storing Li ions in rechargeable batteries.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### Example 1

1a. Electrolyte Preparation and Coin Cell Assembly. Fluorinated cosolvents were blended with 1:1 volume ratio dioxolane (DOL):dimethoxyethane (DME) at a 1:9 volume ratio of cosolvent to DOL:DME. Separate salts (LiTFA, LiTFSM, LiTFSI, LiCF₃SO₃) were dissolved in each solvent blend at 1M concentration, along with 0.3 M lithium nitrate (LiNO₃) which aids in SEI formation at the Li anode surface. A baseline electrolyte of 1M salt in DOL:DME solvent blend with no fluorinated cosolvent was also prepared for each salt. Each electrolyte was incorporated into a 2032-coin cell with a lithium foil anode, sulfur cathode (loading: 3.0-3.5 mg S/cm²), and a polypropylene separator. Cells were built with both bare Li anode and protected Li with a polymer-MXene-based ASEI applied to the surface. To apply the ASEI coatings on the Li metal anode, the coating was first applied to a separate substrate and then transferred onto Li metal. The layer-by-layer (LbL) film application process was used to deposit a transferrable coating to the Li metal surface. Solutions of PEO and PAA (0.2 mg/ml, pH 2.5) were alternately sprayed onto a fluorinated ethylene propylene (FEP) substrate. Prior to deposition, the FEP substrate was plasma treated for 30 seconds followed by a single dip-coated layer. Up to 24 layers of PEO/PAA were deposited on the FEP via spray coating. After this layer was deposited, the samples were dried at 70° C. for 2 hours. Graphene oxide, MXenes and PAH were each used at a 0.2 mg/ml concentration and pH was balanced to 7.4. First, a bilayer of graphene oxide was deposited followed by a layer of poly(allylamine HCl). This layer was necessary to preserve the film integrity during the spraying process. Next, MXene and PAH solutions were alternated, spraying for 10 seconds each time with a 5 second rinse step between. Up to 40 bilayers were deposited. Once finished, the coating is air-dried. To transfer the film to Li metal, the coating was placed face-to-face with Li metal in an inert environment and sealed inside a foil pouch. This pouch was then fed through a calendar roll press twice to transfer the coating from the FEP substrate to the Li metal surface

Coin cells were assembled in an argon-filled glove box and tested on a Maccor battery cycler. Electrolyte was added at an electrolyte to sulfur (E/S) ratio of 8 μL/mg S. Electrochemical impedance spectroscopy (EIS) was performed from 10 Hz to 10000 Hz before electrochemical cycling. Following EIS screening, low temperature testing was performed in a Test Equity environmental chamber. Each coin cell was cycled three times at a C/10 rate at room temperature (RT), followed by low temperature cycling at −20° C. and −40° C. Lithium bis (trifluoromethanesulfonyl) imide (LiTFSI) dissolved in 1:1 volume ratio DOL:DME+LiNO₃ was used as the standard electrolyte. Ionic conductivity was evaluated via EIS testing and CV analysis was used to evaluate electrolyte electrochemical stability.

Ionic Conductivity. The Li-ion conductivity of each electrolyte formulation was compared to the baseline electrolyte (1M LiTFSI and 0.3 M LiNO₃ in 1:1 vol. % DOL:DME), with results tabulated in Table 1:

TABLE 1
Table1. RT lithium ion conductivity of the electrolyte formulations

| | LiTFA | LiTFMSM | LiTFSI | LiCF₃SO₃ |
|---|---|---|---|---|
| | (mS/cm) | (mS/cm) | (mS/cm) | (mS/cm) |
| 1,1,1,3,3,3-hexafluoro-2-methoxypropane | 0.32 | 1.72 | 8.27 | 1.09 |
| 2,2,2-trifluoroethyl acetate | 0.22 | 2.36 | 12.25 | 1.35 |
| 1,1,1,3,3,3-hexafluoropropan-2-yl acetate | 0.16 | 1.38 | 2.79 | 0.50 |
| tris(1,1,1,3,3,3-hexafluoropropan-2-yl) phosphate | 0.38 | 0.39 | 4.62 | 0.72 |
| bis(2,2,2-trifluoroethyl) sulfite | 0.36 | 2.64 | 1.61 | 0.71 |
| bis(2,2,2-trifluoroethyl) ether | 2.70 | 3.35 | 0.67 | 0.53 |
| propyl 1,1,2,2-tetrafluoroethyl ether | 1.20 | 1.12 | 0.70 | 0.81 |
| 1,1,2,2-tetrafluoroethyl-2,2,3,3-tetrafluoropropyl ether | 1.07 | 1.00 | 15.17 | 0.54 |
| 1,1,2,2-tetrafluoroethyl 2,2,2-trifluoroethyl ether | 0.73 | 1.33 | 12.74 | 0.49 |
| ethyl-1,1,2,2-tetrafluoroethyl ether | 0.69 | 3.17 | 1.33 | 0.79 |
| DOL:DME | 1.36 | 2.53 | 2.20 | 1.00 |

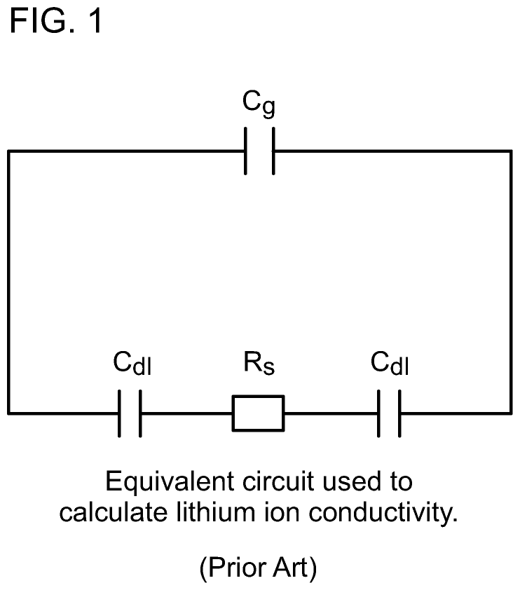

A small solution resistance (Rₛ) and charge-transfer resistance (R_{ct}) value is indicative of good ionic conductivity at room temperature (RT). Rₛ is determined from the Nyquist plot curve where the EIS impedance data intercepts the X-axis at the high frequency region and Rₛ directly translates to the ionic conductivity of the electrolyte. The R_{ct} is associated with the electronic conductivity of the electrodes (cathode/anode) at the electrolyte interface. Each impedance plot was used to model the equivalent circuit shown in FIG. 1 using Z-view 2.0 software. Rₛ represents the electrolyte resistance, C_{dl} represents the capacitive coupling between the ionic conduction in the electrolyte and the electronic conduction in the measuring circuit. Additionally, C_{g} is the geometrical capacitance representing the capacitive effects of the cell hardware and of the electrical leads. The electrolyte conductivity was calculated using Rₛ, thickness of the separator membrane (t) and the surface area of the electrolyte sample (A) using the equation given below:

$$σ = \frac{t}{R s \times A}$$

The room temperature conductivities of the fluorinated cosolvent electrolytes are ˜10⁻³ S/cm, which is comparable to the baseline electrolyte. Notably, the conductivity of solvent blends comprising LiTFSI salt dissolved in DOL/DME/fluorinated co-solvent was 6 to 7-fold higher than values measured for electrolytes without fluorinated co-solvent. For example, the conductivity of electrolytes containing TFETFEE, 1,1,2,2-tetrafluoroethyl-2,2,3,3-tetrafluoropropyl ether (TFETFPE) and 2,2,2-trifluoroethyl acetate fluorinated cosolvents was 12.74 mS/cm, 15.17 mS/cm, and 12.25 mS/cm, respectively. By comparison, the conductivity of the baseline electrolyte is 2.20 mS/cm. The improved performance with fluorinated cosolvent electrolytes could be attributed to the enhanced lithium ion transport facilitated by the positive interaction of the fluorinated co-solvents with DOL and DME.

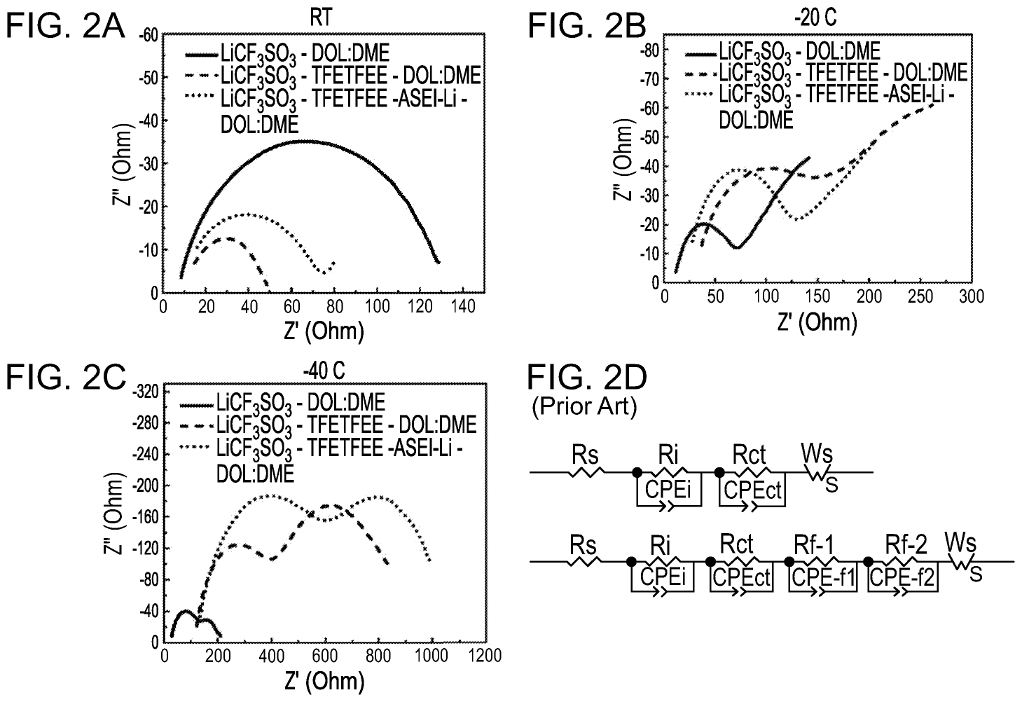

Electrochemical Impedance Spectroscopy (EIS) and Cyclic Voltammetry (CV) Analysis. The Nyquist plot of 1M LiCF₃SO₃+0.3M LiNO₃ in DOL:DME (1:1 vol. %) shows higher solution resistance (Rₛ), charge transfer resistance (R_{ct}) and interface resistance (Ri) at RT compared to electrolytes with TFETFEE cosolvent and Li anode protected with an LbL polymer-MXene ASEI, as shown in FIG. 2A. The Nyquist plots were fitted using Versa studio 2.0 software and the equivalent circuit shown in FIG. 2D. At −20° C., both TFETFEE and TFETFEE-ASEI-protected Li anode increased the Rct and Ri due to the formation of an SEI that stabilizes the Li anode, as shown in FIG. 2B. The TFETFEE-ASEI Li anode cell shows decreased Rct and Ri, plotted in FIG. 2C, which explains the good low-temperature performance. Additional cycling was performed with Li anodes coated with a LbL polymer-MXene ASEI protection layer. This ASEI layer has been demonstrated to improve the cycle life of Li—S cells.

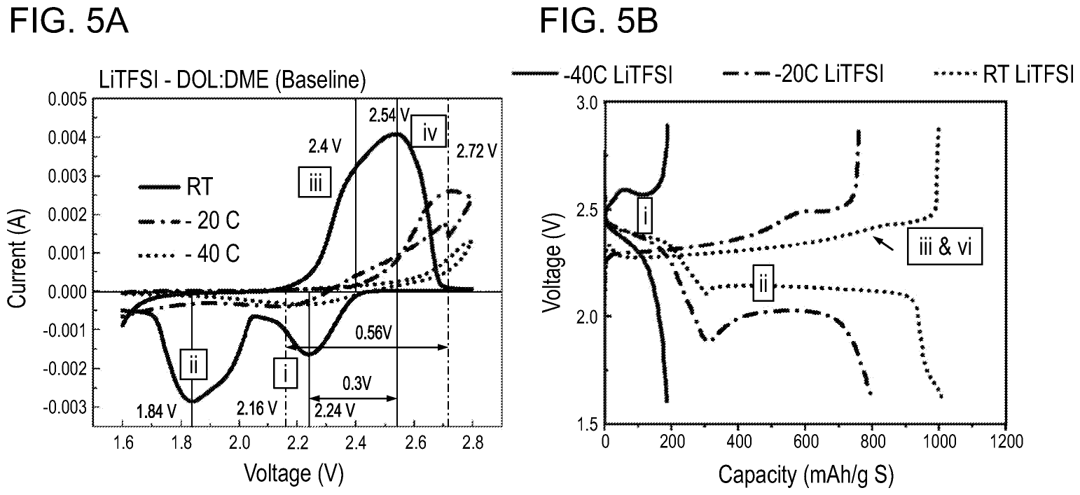

I. CV of Baseline Cells. CV analysis was performed on 2032-coin cells constructed with a sulfur cathode, lithium anode and baseline electrolyte (1M LiTFSI+0.3M LiNO₃ in 1:1 vol. % DOL:DME) at a very slow scan rate of 0.1 mV/s to register all the chemical reactions that occur during electrochemical charge-discharge cycling. FIG. 5A shows CV curves of baseline cells at RT, −20° C. and −40° C. The CV of the baseline electrolyte at RT has two cathodic peaks at 2.24V and 1.84V which correspond to Reactions i and ii, respectively. These peaks translate to the two discharge plateaus of the charge-discharge profile from FIG. 5B. In addition, two anodic peaks corresponding to Reaction iii and Reaction iv are observed at 2.4V and 2.54V, respectively. These anodic peaks correspond to the charge plateau from FIG. 5A at RT. The RT overpotential for the redox reaction at RT is 0.3V. At −20° C., a cathodic peak and anodic peaks are observed at 2.16V and 2.72V respectively. The overpotential for the redox reaction increases to 0.56V at −20° C. which is evident from FIG. 5A. At −40° C., no cathodic and anodic peaks are observed in the CV due to the absence of sulfur conversion. We attribute this result to the poor ionic conductivity of the electrolyte at −40° C.

xS₈+yLi⁺+ye⁻⇒zLi₂Sₓ Reaction i:

Li₂Sₓ+mLi⁺+me⁻⇒xLi₂S Reaction ii:

Li₂S⇒Li₂Sₚ+nLi⁺+ne⁻ Reaction iii:

Li₂Sₚ⇒S₈+xLi⁺+xe⁻ Reaction iv:

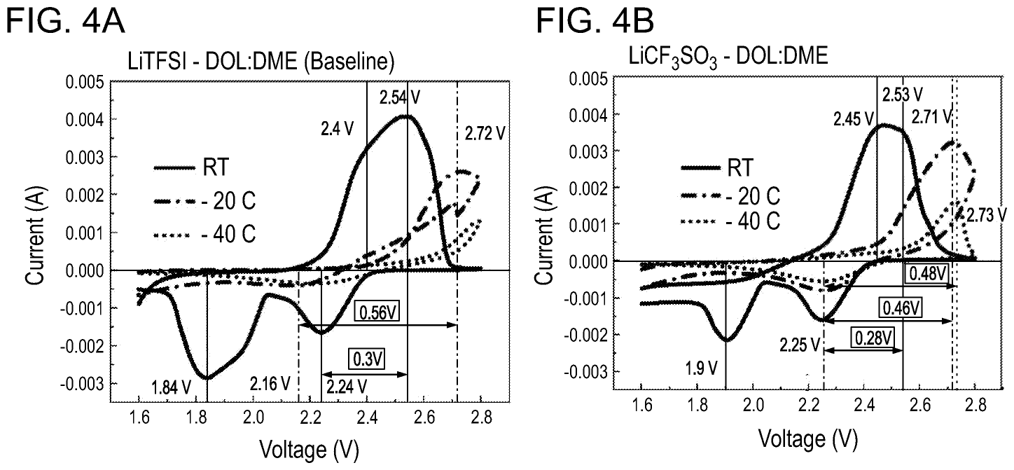

II. Effect of Strongly Bound Li-Salt at Low-Temperature Conditions. FIG. 4A represents the CV of baseline electrolyte compared to 1M LiCF₃SO₃+0.3M LiNO₃ in DOL:DME (50:50 vol %) (FIG. 4B) The baseline CV has the characteristic peaks of the sulfur redox reaction at RT and −20° C. The CV with 1M LiCF₃SO₃+0.3M LiNO₃ in DOL:DME (50:50 vol %) (FIG. 4B) shows a RT overpotential of 0.28V lower than the baseline electrolyte. Compared to the baseline electrolyte, the strongly bound electrolyte exhibits redox peaks at −40° C. at 2.25V and 2.73V. The overpotential at −20° C. (0.46V) is also lower for the LiCF₃SO₃ based electrolyte. From the results of the CV analysis, it is evident that the strongly bound Li-salt facilitates sulfur conversion reaction at −40° C.

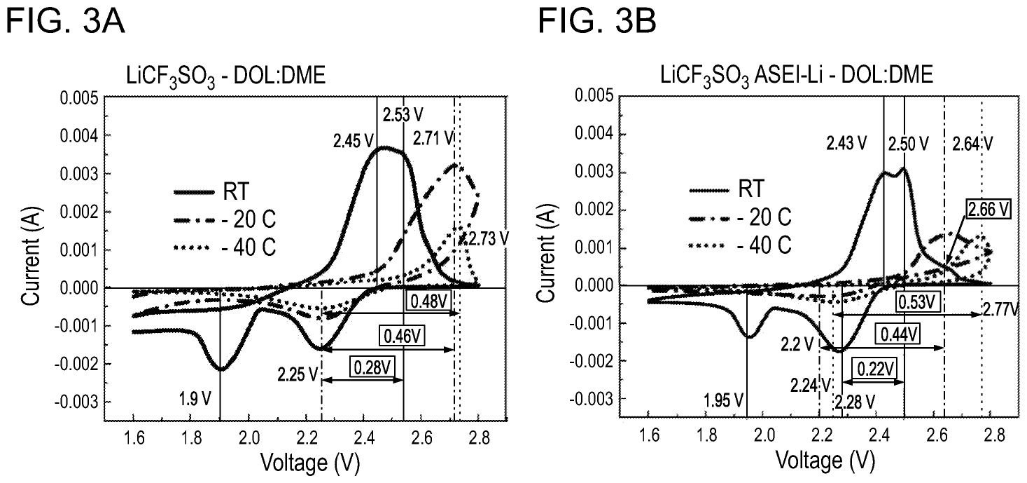

III. Effect of ASEI Anode on Low-Temperature Performance. FIGS. 3A and 3B represents the CV of 1M LiCF₃SO₃+0.3M LiNO₃ in DOL:DME (50:50 vol %) without ASEI, as shown in FIG. 3A, and with ASEI, as shown in FIG. 3B. The cells with ASEI protected anode show lower overpotential for sulfur redox reaction at RT (0.28V) and −20° C. (0.44V) compared to the cells without protected anode. In addition, the cells with LBL anode has a significant reduction in peak intensity at 1.9-1.95V (Reaction ii), due to reduced polysulfide reaction. The LBL anodes also forms a stable SEI as evident from the irreversible peak at 2.66V.

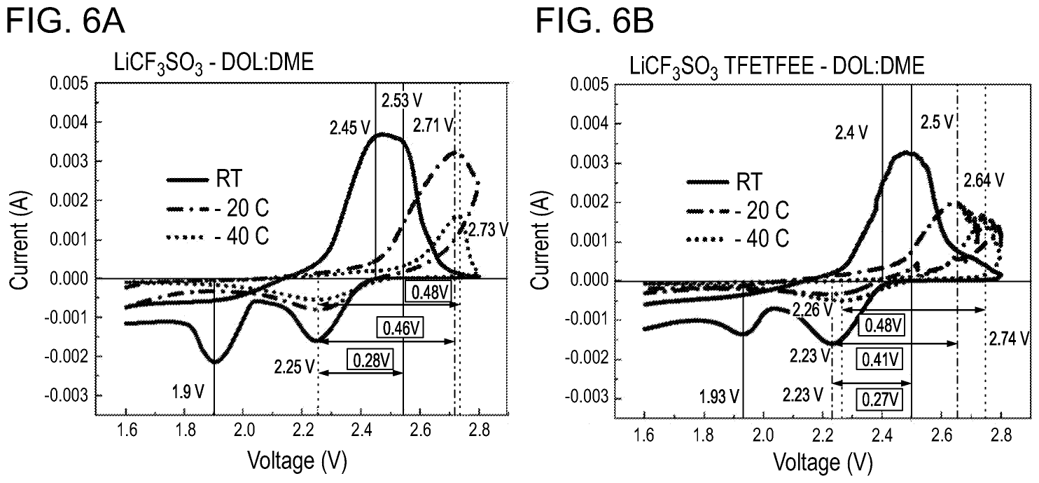

IV. Effect of Fluorinated Cosolvent on Low-Temperature Performance. FIG. 6 represents the CV of 1M LiCF₃SO₃+0.3M LiNO₃ in DOL:DME (50:50 vol %) without, as shown in FIG. 6A, and with, as shown in FIG. 6B, 10 vol % TFETFEE cosolvent additive. The addition of 10 vol % fluorinated cosolvent (TFETFEE) lowers the overpotential for sulfur redox reaction at RT (0.27V) and −20° C. (0.41V) compared to the cells without fluorinated cosolvent additive. The cells with fluorinated cosolvent has a significant reduction in peak intensity at 1.9-1.95V (Reaction ii), due to reduced polysulfide reaction. However, the fluorinated cosolvent electrolyte reacts with the Li-metal anode at −20° C. as evident from the noisy anodic peak in the CV between 2.6V and 2.8V, as shown in FIG. 6B. The fluorinated cosolvent electrolyte helps decrease polysulfide dissolution and enable sulfur conversion reaction at −40° C.

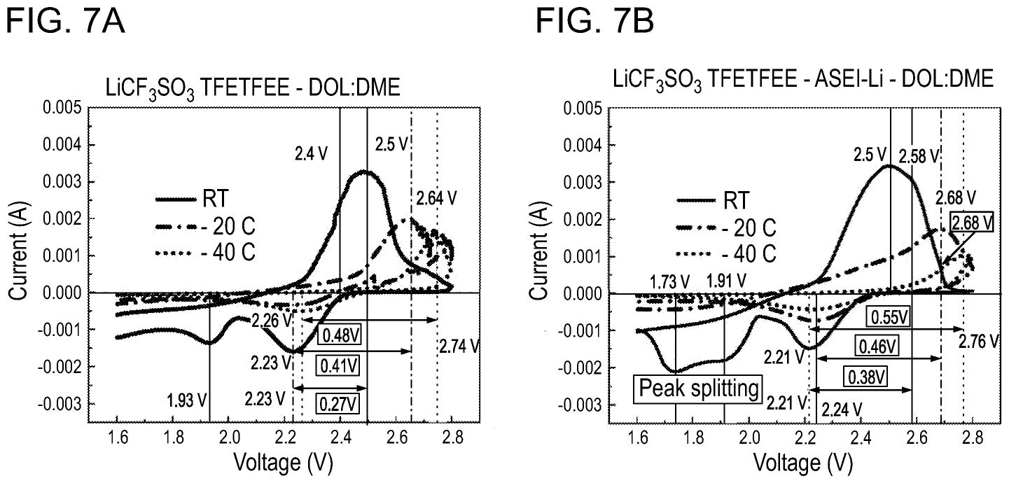

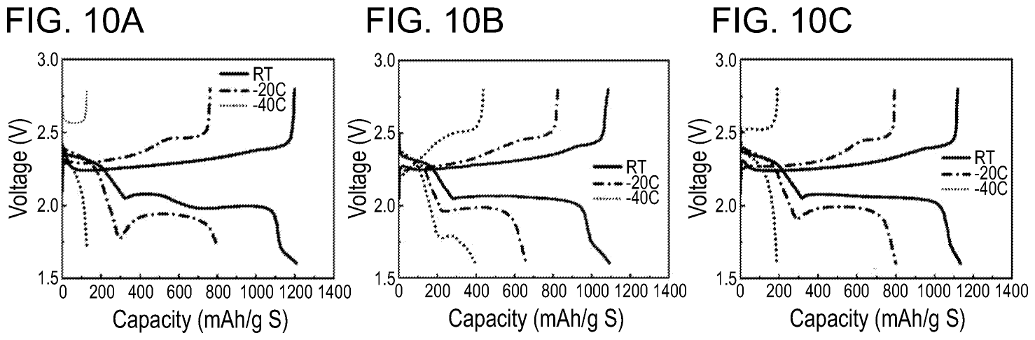

V. Combined Effect of ASEI Anode and Fluorinated Cosolvent on Low-Temperature Performance. FIGS. 7A and 7B represent the CV of 1M LiCF₃SO₃+0.3M LiNO₃ in DOL:DME (50:50 vol %) with 10 vol % TFETFEE cosolvent and bare Li foil, as shown in FIG. 10A, and with LBL anode in addition to 10 vol % TFETFEE cosolvent additive, as shown in FIG. 10B. An irreversible peak is observed at 2.68Vin addition to peak splitting between 1.7-1.9V, as shown in FIG. 7B, due to SEI formation at the anode. Overall, the ASEI-protected Li when combined with fluorinated cosolvent electrolyte (10 vol. % TFETFEE) reduces polysulfide dissolution and provides a stable SEI layer.

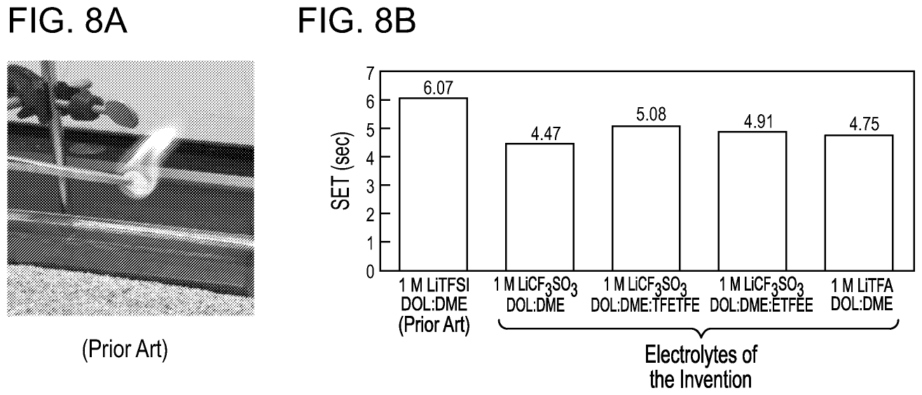

Flammability. Electrolyte flammability was compared to the baseline electrolyte. Self-extinguishing time (SET) measurements were used to compare electrolyte flammability. Glass filter paper disks of the same size were soaked in each electrolyte, exposed to an ignition source and time between removal of the ignition source and the flame self-extinguishing was recorded, as shown in FIGS. 8A and 8B. This was done in triplicate for each electrolyte tested. The baseline electrolyte (1 M LiTFSI in 1:1 vol. % DOL:DME) has a SET of 6.07 seconds. The non-baseline electrolytes all demonstrated lower SET values ranging from 4.47 sec-5.08 sec, which represents a reduction of 16-25% compared to the baseline electrolyte.

Electrochemical Screening at Low Temperature in Coin Cells. After impedance analysis, each composition was evaluated for electrochemical performance at RT, −20° C., and −40° C. in coin cells. Each electrolyte was run in triplicate and cycled at C/10 rate from 1.6 V to 2.8 V.

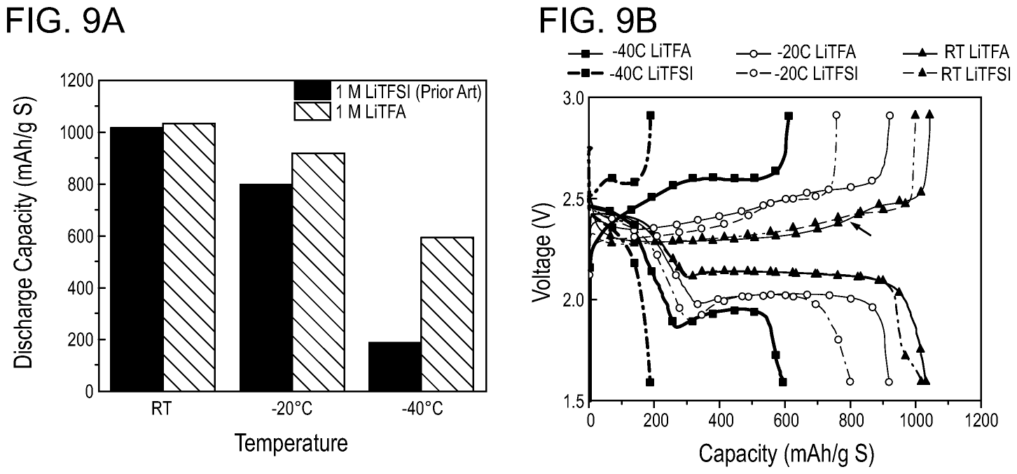

Low Temperature Electrochemical Performance. At −40° C. cycling conditions, the baseline electrolyte comprising 1 M LiTFSI in 1:1 vol. % DOL:DME is unable to provide capacity above 200 mg S/cm² due to the incomplete conversion reaction of S₈ to Li₂S. However, by switching from LiTFSI to LiTFA salt, low temperature capacity was increased and a liquid phase reaction was retained, as shown in FIGS. 9A and 9B. The blue curve, corresponding to room temperature cycling, shows a classic two plateau curve. For both LiTFSI and LiTFA, the initial plateau at ˜2.4 V corresponds to conversion of the solid S₈ to the initial polysulfides which are soluble in the liquid electrolyte. The second plateau at ˜2.05 V corresponds to the liquid phase conversion of several polysulfide intermediates to the final insoluble Li₂S product. At room temperature, both salts perform similarly. The shape of the voltage profile at −20° C., however, clearly shows the limitations of the baseline electrolyte at low temperature conditions. While the baseline LiTFSI electrolyte retains the characteristic two voltage plateaus at −20° C., a large dip in voltage between the two plateaus is observed. This result indicates that the reaction kinetics are significantly reduced in the baseline electrolyte system at −20° C., thus causing a significant increase in cell over-potential. At −40° C., the baseline electrolyte does not show a second voltage plateau at ˜2.05 V, which severely reduces capacity. Without the liquid phase conversion reactions, the baseline electrolyte cell performance is limited to a capacity of only 200 mAh/g S. In contrast, the LiTFA salt electrolyte exhibited a clear second plateau at −20° C. There is no noticeable dip in voltage between the two plateaus and the voltage plateau at −20° C. is only 60 mV lower compared to the RT voltage plateau. This indicates that the LiTFA electrolyte conductivity and ion mobility is comparable to RT cycling conditions. At −40° C., the LiTFA electrolyte shows a second voltage plateau which supports the presence of liquid phase conversion reactions even at this extreme cycling condition. At −40° C., the LiTFA electrolyte achieved a discharge capacity of 593 mAh/g S, which represents a 52% retention of the room temperature capacity.

Three additional electrolyte compositions were developed with LiCF₃SO₃, which provided improved low temperature performance over the baseline composition. As shown in FIG. 10A, LiCF₃SO₃ without a fluorinated co-solvent shows elimination of the second voltage plateau at −40° C. test conditions. At −40° C., the charge curve does not exhibit any plateau and polarizes almost immediately, suggesting liquid phase recharging is not occurring. However, the addition of 10% TFETFEE to this electrolyte system eliminates this extreme over-potential at −40° C. and regains the second plateau during discharge, as shown in FIG. 10B. A separate composition, LiCF₃SO₃ in DOL:DME with 10% ETFEE, did not enable a plateau at −40° C. However, the charge curve was better resolved suggesting that liquid phase reactions are occurring, as shown in FIG. 10C.

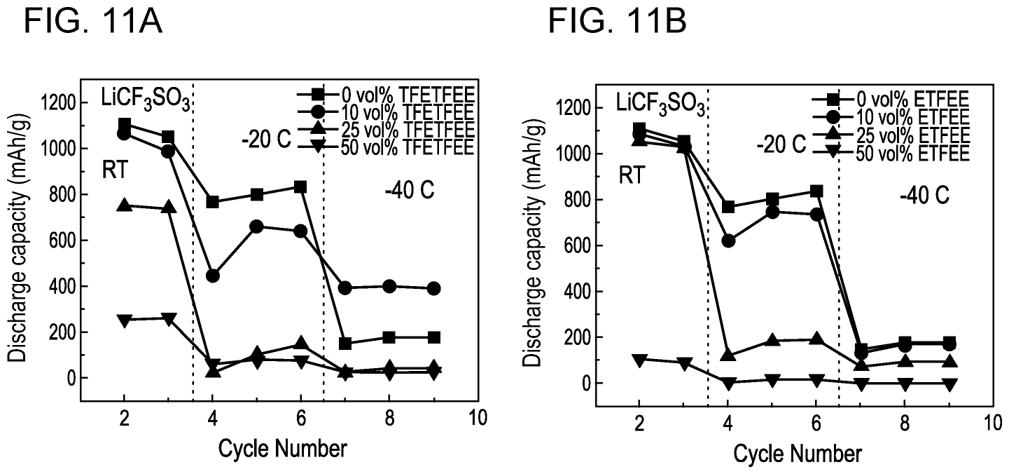

The composition of fluorinated co-solvent in the electrolyte was evaluated at a volume % content of 0%, 10%, 25%, and 50%, as shown in FIGS. 11A and 11B. In the case of TFETFEE and ETFEE, increasing the cosolvents to over 10% of the total solvent volume leads to reduced performance. The likely reason for this is decreased solubility of the salt with decreasing temperature. LiCF₃SO₃ is soluble in DOL:DME, but to a much lower extent in the fluorinated co-solvents. At 1 M concentration and room temperature conditions, the LiCF₃SO₃ salt is fully dissolved in DOL:DME. As the volume percent of DOL and DME is reduced by addition of fluorinated cosolvents, the concentration of dissolved salt also decreases. Therefore, at lower temperatures, the viscosity of electrolyte and precipitation of salt severely hinders the reaction kinetics reducing the capacity of the cells.

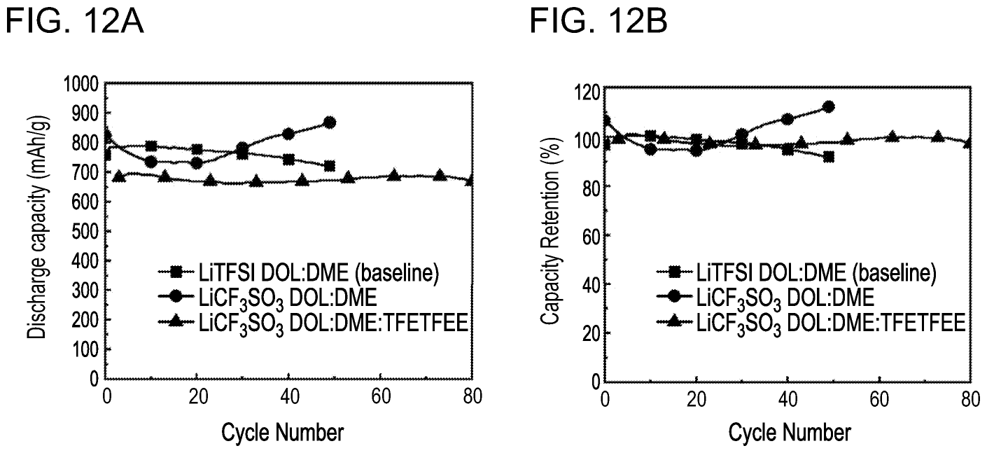

Low Temperature Cycle Life Evaluation. Electrolyte formulations were cycled at −20° C. in coin cells. Specifically, the electrolyte systems evaluated were: 1M LiCF₃SO₃ dissolved in either DOL:DME or DOL:DME:TFETFEE (9:9:2 volume ratio). The baseline electrolyte (1M LiTFSI in DOL:DME) was also cycled at −20° C. for comparison. Cycle life testing is shown in FIGS. 12A and 12B. Both the baseline, LiCF₃SO₃ in DOL:DME, and fluorinated co-solvent electrolytes show stable cycling performance.

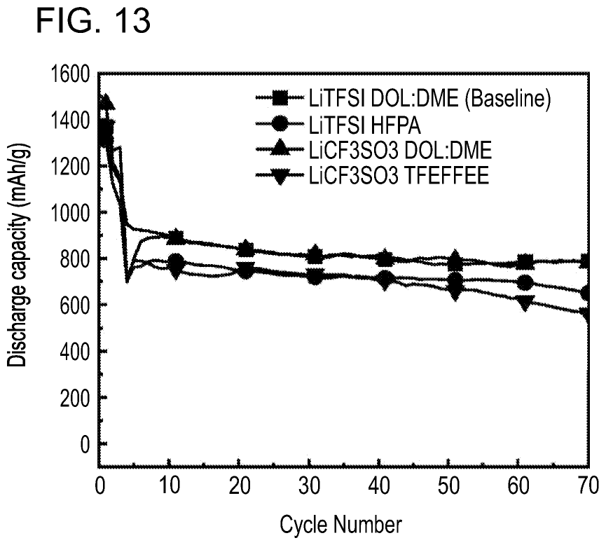

Room Temperature Cycle Life Evaluation. The following electrolytes were evaluated for RT cycle testing: (1) LiTFSI in 1,1,1,3,3,3-hexafluoropropan-2-yl acetate (HFPA), (2) LiCF₃SO₃ in DOL:DME, and (3) LiCF₃SO₃ in DOL:DME:TFETFEE (9:9:2 volume ratio) (FIG. 13). Electrolyte formulations were cycled at RT and their performance was compared with the baseline electrolyte (LiTFSI in DOL:DME) cycled at RT. The cycling experiment was performed at C/5 rate following 3 initial formation cycles at C/20 rate.

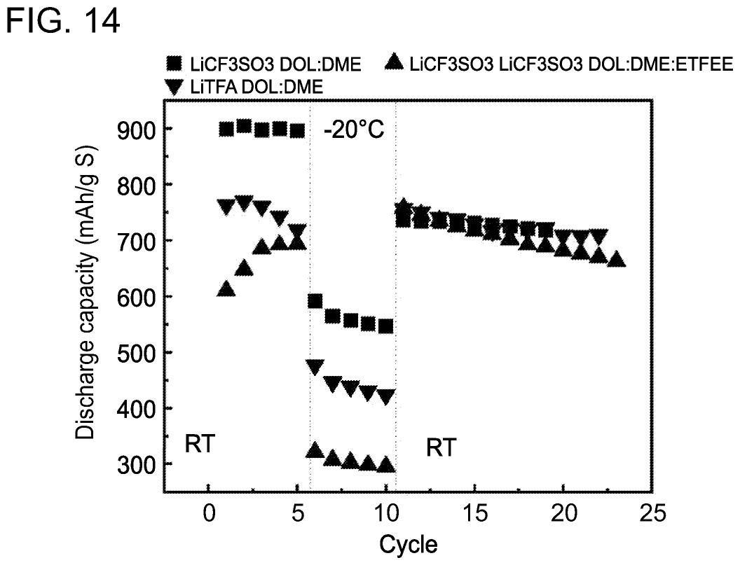

Room Temperature (RT) Performance Recovery after Low Temperature Exposure. One important performance requirement is the ability to recover performance after exposure to low temperature conditions. Cells were returned to room temperature cycling after completing a −40° C. cycling protocol. Electrolyte formulations (LiCF₃SO₃ in DOL:DME, LiCF₃SO₃ in DOL:DME:TFETFEE (9:9:2 volume ratio) and LiTFA in DOL:DME) were tested at RT after cycle testing at −20° C., as shown in FIG. 14. The results indicate that the LiCF₃SO₃ in DOL:DME and LiTFA in DOL:DME electrolytes regained their initial discharge capacity even after being cycled at −20° C. The electrolyte consisting of LiCF₃SO₃ in DOL:DME:TFETFEE (9:9:2 volume ratio) recovers 82% of its RT capacity and exhibits stable cycling after low temperature cycling.

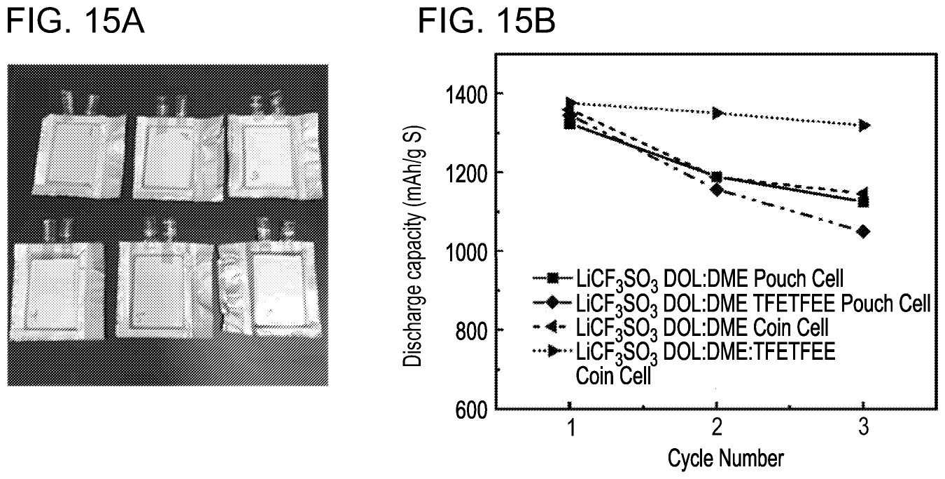

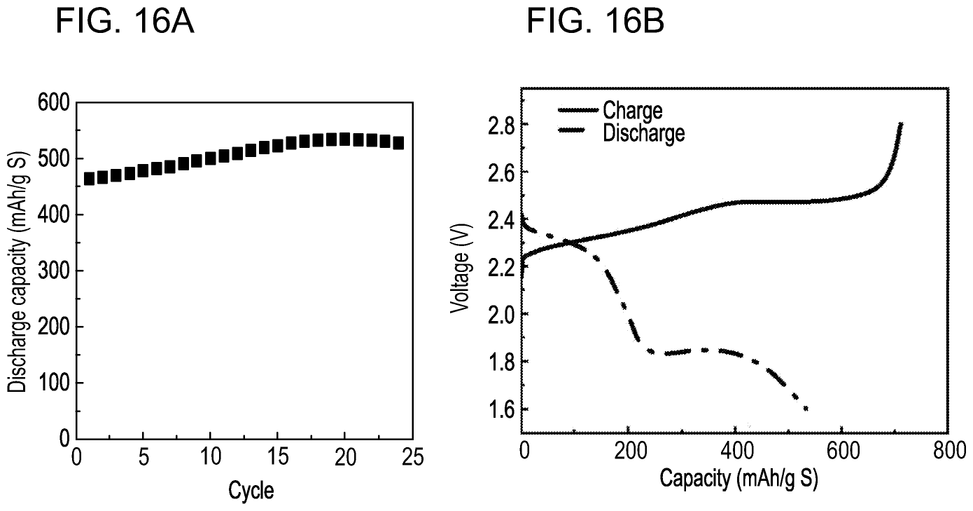

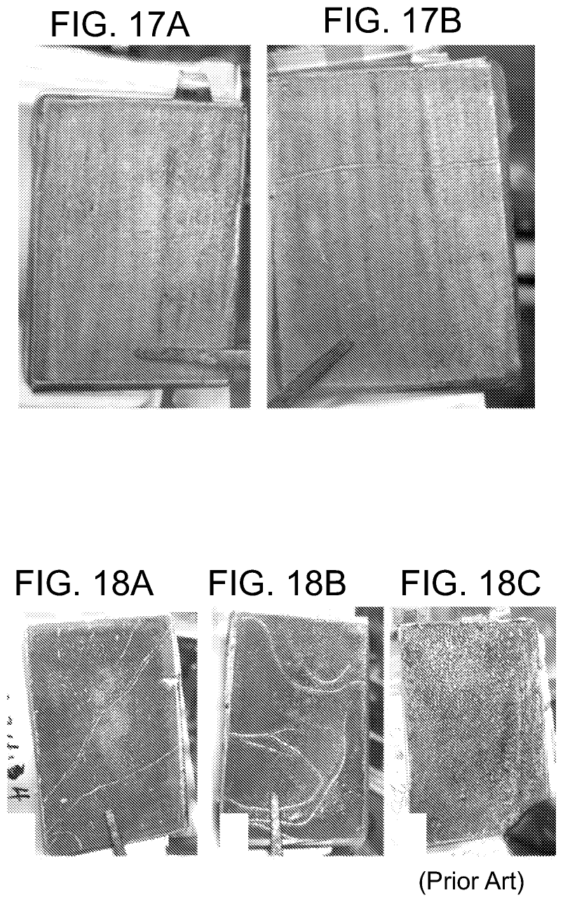

Electrolyte Performance in Single Layer Pouch Cells. Single layer pouch (SLP) cells with a form factor of 3.8 cm×5.5 cm and an active area of 20 cm² were assembled, as shown in FIG. 15A. SLPs were assembled with two different types of low temperature electrolytes (LiCF₃SO₃ in DOL:DME and LiCF₃SO₃ in DOL:DME:TFETFEE) at an electrolyte to sulfur ratio of 8 μL/mg S. Cells were compressed between two plates to maintain contact between electrodes during cycling. Six (6) SLPs were fabricated and formation cycling was performed at room temperature. Increasing the cell size from coin cell to pouch cell format dramatically changes the wetting, compression, and current density uniformity which are all parameters that can affect cell performance. Therefore, it is important to evaluate new cell components in the pouch cell format to demonstrate scale up capabilities. As shown in FIG. 15B, gravimetric capacity at both the pouch cell and coin cell level is nearly identical for the LiCF₃SO₃ in DOL:DME electrolyte. The demonstration of performance retention in a larger format cell indicates that the developed electrolytes can be incorporated into a practical cell without loss of performance. Pouch cells were also evaluated at −20° C. (FIG. 17). Initial cycles at the lower temperature did not exhibit the second plateau, however, after cycle 20 the second plateau was resolved resulting in stable cycling at 532 mAh/g S, as shown in FIG. 16B. 25 cycles of steady cycling at −20° C. have been demonstrated above 500 mAh/g S, as shown in FIG. 16A.

Postmortem Analysis. Postmortem analysis was conducted on cycled and uncycled pouch cells to evaluate electrolyte compatibility and failure mechanisms. The failure mechanism in Li—S batteries is typically dictated by anode corrosion and electrolyte consumption. SLPs with the best performing electrolytes were disassembled after completion of three formation cycles. For comparison, SLPs with baseline electrolyte were also evaluated via postmortem analysis. Disassembly of SLPs assembled with the developed low temperature electrolytes (1 M LiCF₃SO₃ and 0.3 M LiNO₃ in DOL:DME and 1 M LiCF₃SO₃ and 0.3 M LiNO₃ in DOL:DME:TFETFEE) showed an even SEI layer coating on the Li anode surface, with no significant pitting or corrosion degradation, as shown in FIGS. 18A and 18B. This indicates that the Li anode is compatible with the low temperature electrolytes.

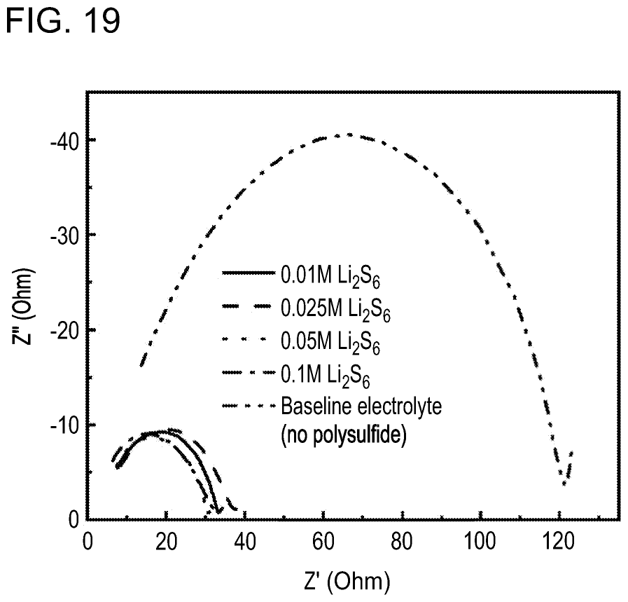

Postmortem analysis was also conducted on SLPs exposed to −20° C. cycling conditions. As shown in FIGS. 19A and 19B, cycling with the low temperature electrolytes showed formation of a thick SEI layer at −20° C. However, the Li surface of the low temperature electrolyte SLPs exhibit significantly less pitting and corrosion compared to Li anodes harvested from baseline electrolyte SLPs, as shown in FIG. 19C. SLPs cycled with baseline electrolyte show significant corrosion and electrolyte decomposition at the Li metal anode surface.

### Example 2

Preparation of Polysulfide Pre-Dissolved Electrolyte: The polysulfide pre-dissolved electrolytes were prepared by dissolving fixed concentrations of polysulfides in the baseline electrolyte (1.0 M LITFSI and 0.3 M LiNO₃ in 50:50 vol % DOL:DME). First, stochiometric quantities of Li₂S and sulfur (S₈) were calculated using Equation 1.

xLi2S+yS₈<=>xLi2S₆ Equation 1

The pre-determined amounts of Li₂S and S₈ were then dissolved in the baseline electrolyte at 60° C. for 12 hours under argon atmosphere. Four different electrolytes with Li₂S₆ concentration varying between 0.01 M-0.1 M were prepared and tested in coin cells using lithium metal as anode and a baseline cathode at E/S of 8 μl/mg S. The coin cells were cycled between 1.6 V and 2.8 V at C/5 rate following 3 formation cycles at C/20 rate. Electrochemical impedance Spectroscopy (EIS) was performed on all the coin cells at the open circuit potential (OCP).

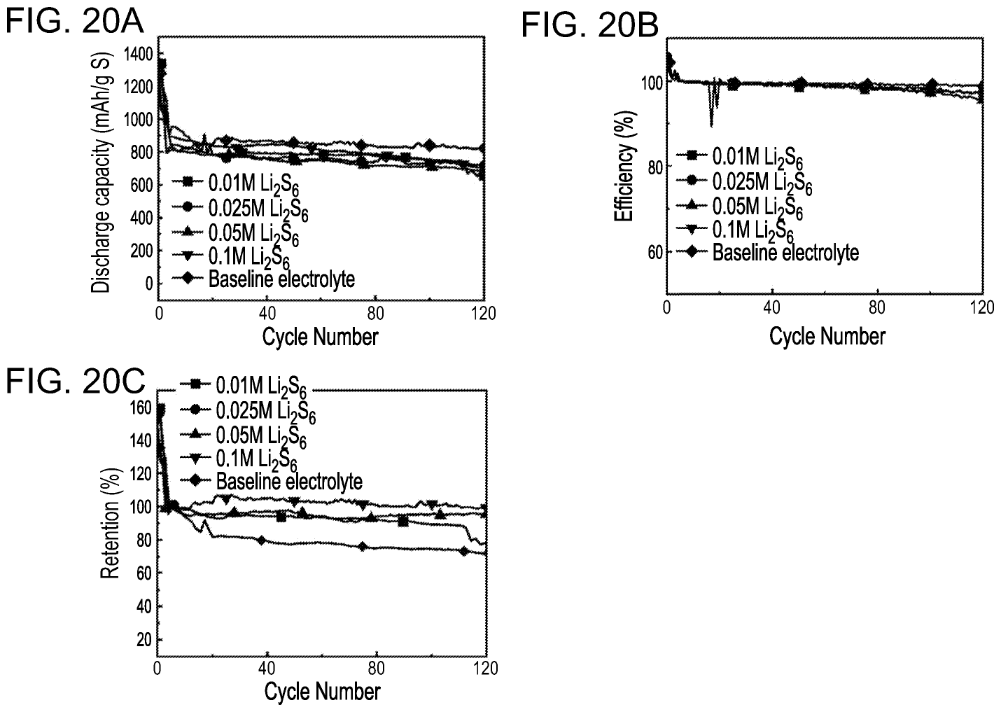

Impedance and Cycling with Pre-Dissolved Polysulfide Electrolyte: FIG. 20 represents the Nyquist plot of the baseline electrolyte compared with the polysulfide pre-dissolved electrolytes. The baseline electrolyte showed a larger semicircle (120Ω-X-intercept). However, all the polysulfide pre dissolved electrolytes showed lower impedance (˜30-40Ω X-intercept). This 3-4-fold reduction in impedance shows that the polysulfide pre-dissolved electrolytes have better ionic conductivity and wetting characteristics compared to the baseline electrolyte.

FIGS. 21A through 21C represent plots of electrochemical cycling tests. Each data set is an average of 3 cells. Baseline electrolyte formulation exhibited an initial capacity of 1350 mAh/g-S at C/20 formation rate and 917 mAh/g at C/5 rate. The baseline performance fades to 702 mAh/g at 100 cycles. The best performing 0.1 M Li₂S₆ polysulfide dissolved electrolyte on the other hand shows an initial capacity of 820 mAh/g-S at C/5 rate and 865 mAh/g after 100 cycles. The discharge capacity and fade rate are summarized in Table 2:

TABLE 2
Table 2. Summary of the electrochemical cycling results.

| | Initial | 100^{th} cycle | | |
|---|---|---|---|---|
| | discharge | discharge | | |
| | capacity | capacity | | |
| | at C/5 rate | at C/5 rate | Fade rate | % Retention |
| Electrolyte | (mAh/g) | (mAh/g) | (%/cycle) | at cycle 100 |
| Baseline | 917 | 702 | 0.23 | 76.5 |
| 0.01M Li₂S₆ | 847 | 748 | 0.12 | 88.3 |
| 0.025M Li₂S₆ | 850 | 772 | 0.09 | 90.8 |
| 0.05M Li₂S₆ | 868 | 820 | 0.06 | 94.4 |
| 0.1M Li₂S₆ | 820 | 865 | −0.05 | 105.4 |

The baseline electrolyte exhibited a fade rate of 0.23%/cycle. The polysulfide pre-dissolved electrolytes 0.01 M Li₂S₆, 0.025 M Li₂S₆, 0.05 M Li₂S₆ and 0.1M Li₂S₆ exhibited a fade rate of 0.12%, 0.09%, 0.06%, and −0.05%, respectively. All the polysulfide pre-dissolved electrolytes showed a lower fade rate compared to the baseline, the 1 M Li₂S₆ shows a negative fade-rate (−0.5%/cycle) due to the favorable effect of the electrolyte on the coin cell cycling which translated to 88.3%, 90.8%, 94.4% and 105.4% retention for 0.01 M, 0.025 M, 0.05 M and 0.1 M Li₂S₆ dissolved in baseline electrolyte, respectively. All the polysulfide pre-dissolved electrolytes also exhibit very good columbic efficiency (>98%) and capacity retention (FIGS. 6b and c). The 0.1 M Li₂S₆ shows a capacity retention greater than 100% due to the contribution from the polysulfides. Addition of pre-dissolved polysulfides resulted in an additional 12-30% capacity retention over the baseline electrolyte by cycle 100.

### REFERENCES

1. Manthiram, A.; Fu, Y.; Su, Y.-S., Challenges and Prospects of Lithium-Sulfur Batteries. Accounts of Chemical Research 2013, 46 (5), 1125-1134.
2. Peng, L.; Wei, Z.; Wan, C.; Li, J.; Chen, Z.; Zhu, D.; Baumann, D.; Liu, H.; Allen, C. S.; Xu, X.; Kirkland, A. I.; Shakir, I.; Almutairi, Z.; Tolbert, S.; Dunn, B.; Huang, Y.; Sautet, P.; Duan, X., A fundamental look at electrocatalytic sulfur reduction reaction. Nature Catalysis 2020, 3 (9), 762-770.
3. Kim, J. S.; Hwang, T. H.; Kim, B. G.; Min, J.; Choi, J. W. J. A. F. M., A lithium-sulfur battery with a high areal energy density. 2014, 24 (34), 5359-5367.
4. Yoshio, M.; Brodd, R. J.; Kozawa, A., Lithium-ion batteries. Springer: 2009; Vol. 1.
5. Choi, S.; Seo, D. H.; Kaiser, M. R.; Zhang, C.; Han, Z. J.; Bendavid, A.; Guo, X.; Yick, S.; Murdock, A. T.; Su, D. J. J. o. M. C. A., WO 3 nanolayer coated 3D-graphene/sulfur composites for high performance lithium/sulfur batteries. 2019, 7 (9), 4596-4603.
6. Kim, J.; Lee, D. J.; Jung, H. G.; Sun, Y. K.; Hassoun, J.; Scrosati, B. J. A. F. M., An Advanced Lithium-Sulfur Battery. 2013, 23 (8), 1076-1080.
7. Gupta, A.; Bhargav, A.; Jones, J.-P.; Bugga, R. V.; Manthiram, A., Influence of Lithium Polysulfide Clustering on the Kinetics of Electrochemical Conversion in Lithium-Sulfur Batteries. Chemistry of Materials 2020, 32 (5), 2070-2077.
8. Möller, K. C.; Hodal, T.; Appel, W. K.; Winter, M.; Besenhard, J. O., Fluorinated organic solvents in electrolytes for lithium ion cells. Journal of Power Sources 2001, 97-98, 595-597.
9. Smart, M. C.; Ratnakumar, B. V.; Ryan-Mowrey, V. S.; Surampudi, S.; Prakash, G. K. S.; Hu, J.; Cheung, I., Improved performance of lithium-ion cells with the use of fluorinated carbonate-based electrolytes. Journal of Power Sources 2003, 119-121, 359-367.
10. Nakajima, T.; Dan, K.-i.; Koh, M.; Ino, T.; Shimizu, T., Effect of addition of fluoroethers to organic solvents for lithium ion secondary batteries. Journal of Fluorine Chemistry 2001,111 (2), 167-174.
11. Nakajima, T.; Dan, K.-i.; Koh, M., Effect of fluoroesters on the low temperature electrochemical characteristics of graphite electrode. Journal of Fluorine Chemistry 1998, 87 (2), 221-227.
12. Yamaki, J.-I.; Yamazaki, I.; Egashira, M.; Okada, S., Thermal studies of fluorinated ester as a novel candidate for electrolyte solvent of lithium metal anode rechargeable cells. Journal of Power Sources 2001, 102 (1), 288-293.
13. Smart, M.; Bugga, R.; Prakash, G. K. S.; Smith, K.; Bhalla, P., NASA Tech Brief, NPO-44626 (https://ntrs.nasa.gov/search.jsp?R=20090032095) 2009.
14. Prakash, G. K. S.; Smart, M.; Smith, K.; Bugga, R., Optimized Li-Ion Electrolytes Containing Fluorinated Ester Co-Solvents. NASA Tech Briefs, NPO-45824 (https://ntrs.nasa.gov/search.jsp?R=20100009679) 2010.
15. Gordin, M. L.; Dai, F.; Chen, S.; Xu, T.; Song, J.; Tang, D.; Azimi, N.; Zhang, Z.; Wang, D., Bis(2,2,2-trifluoroethyl) Ether As an Electrolyte Co-solvent for Mitigating Self-Discharge in Lithium-Sulfur Batteries. ACS Applied Materials & Interfaces 2014, 6 (11), 8006-8010.
16. Chen, S.; Yu, Z.; Gordin, M. L.; Yi, R.; Song, J.; Wang, D., A Fluorinated Ether Electrolyte Enabled High Performance Prelithiated Graphite/Sulfur Batteries. ACS Applied Materials & Interfaces 2017, 9 (8), 6959-6966.
17. Azimi, N.; Weng, W.; Takoudis, C.; Zhang, Z., Improved performance of lithium-sulfur battery with fluorinated electrolyte. Electrochemistry Communications 2013, 37, 96-99.
18. Azimi, N.; Xue, Z.; Rago, N. D.; Takoudis, C.; Gordin, M. L.; Song, J.; Wang, D.; Zhang, Z., Fluorinated Electrolytes for Li—S Battery: Suppressing the Self-Discharge with an Electrolyte Containing Fluoroether Solvent. Journal of The Electrochemical Society 2014, 162 (1), A64-A68.
19. Azimi, N.; Xue, Z.; Bloom, I.; Gordin, M. L.; Wang, D.; Daniel, T.; Takoudis, C.; Zhang, Z., Understanding the Effect of a Fluorinated Ether on the Performance of Lithium-Sulfur Batteries. ACS Applied Materials & Interfaces 2015, 7 (17), 9169-9177.
20. Lu, H.; Zhang, K.; Yuan, Y.; Qin, F.; Zhang, Z.; Lai, Y.; Liu, Y., Lithium/sulfur batteries with mixed liquid electrolytes based on ethyl 1,1,2,2-tetrafluoroethyl ether. Electrochimica Acta 2015, 161, 55-62.
21. Xiong, S.; Regula, M.; Wang, D.; Song, J., Toward Better Lithium-Sulfur Batteries: Functional Non-aqueous Liquid Electrolytes. Electrochemical Energy Reviews 2018, 1 (3), 388-402.
22. Yue, Z.; Dunya, H.; Aryal, S.; Segre, C. U.; Mandal, B., Synthesis and electrochemical properties of partially fluorinated ether solvents for lithiumsulfur battery electrolytes. Journal of Power Sources 2018, 401, 271-277.
23. Ehrlich, G. M. U.S. Pat. No. 6,203,949 B1 2001.
24. Nasim Azimi, Z. X., Ira Bloom, Mikhail L. Gordin, Donghai Wang, Tad Daniel, Christos Takoudis, Zhengcheng Zhang, Understanding the Effect of a Fluorinated Ether on the Performance of Lithium-Sulfur Batteries. ACS Appl. Mater. Interfaces 2015, 9169-9177.
25. Chenxi Zu, N. A., Zhengcheng Zhang and Arumugam Manthiram, Insight into lithium-metal anodes in lithium-sulfur batteries with a fluorinated ether electrolyte. Journal of Materials Chemistry A 2015, 14864-14870.
26. Besenhard, J. O.; Von Werner, K.; Winter, M., Fluorine-containing solvents for lithium batteries having increased safety. Google Patents: 1999.
27. Hai Lu, Y. Y., Kai Zhang, Furong Qin, Yanging Lai, Yexiang Liu, Application of Partially Fluorinated Ether for Improving Performance of Lithium/Sulfur Batteries. Journal of The Electrochemical Society 2015, A1460-A1465.
28. Sui Gu, R. Q., Jun Jin, Qingsong Wang, Jing Guo, Sanpei Zhang, Shangjun Zhuob, Zhaoyin Wen, Suppressing the dissolution of polysulfides with cosolvent fluorinated diether towards high-performance lithium sulfur batteries. Physical Chemistry Chemical Physics 2016, 29293-29299.

The relevant teachings of all patents, patent applications, and publications, including all references cited herein and above, are incorporated herein by reference in their entirety. In addition, the relevant teachings of “Electrochemical Devices Utilizing MXene-Polymer Composites,” by Castro Laicer, Mario Moreira, and Katherine Harrison, Attorney Docket No.: GIN-00225, filed on Apr. 14, 2022, are also incorporated by reference in their entirety.

What is claimed is:

1. An electrolyte, comprising:
a) a lithium (Li) salt;
b) a fluorinated solvent;
c) 1,3-dioxolane (DOL) solvent;
d) 1,2-dimethoxyethane (DME) solvent;
e) lithium polysulfide (LiPS); and
f) lithium nitrate (LiNO₃).

2. The electrolyte of claim 1, wherein the Li salt includes at least one member of the group consisting of lithium trifluoromethane sulfonate (LiCF₃SO₃), lithium trifluorosulfonyl methane (LiTFSM), lithium trifluoroacetate (LiTFA), and lithium bis(fluorosulfonyl)imide (LiFSI).

3. The electrolyte of claim 1, wherein the Li salt includes at least one member of the group consisting of lithium bis(trifluoromethanesulfonyl)imide (LiTFSI), lithium bis(trifluoromethylsulfonyl)imide (LiTFSI), and lithium trifluoromethanesulfonate (LiTf), lithium nonafluoro-1-butane sulfonate (Li(CF₃(CF₂)₃)SO₃), lithium acetate (LiCH₃SO₂), lithium bis(trifluoromethanesulfonyl)imide (Li(CF₃SO₂)₂N), lithium (fluorosulfonyl)-(trifluoromethanesulfonyl)imide (Li(FSO₂)(CF₃SO₂)N), lithium bis(pentafluoroethanesulfonyl)imide (Li(CF₃CF₂SO₂)₂N), lithium bis(nonafluorobutanesulfonyl)imide (Li(C₄F₉SO₂)₂N), lithium tris(trifluoromethanesulfonyl) methide (Li(CF₃SO₂)₃C, LiBF₄, LiBF₃(C₂F₅), LiB(C₂O₄)₂, LiB(C₆F₅)₄, LiPF₃(C₂F₅)₃, LiClO₄, LiPF₆, LiAsF₆, LiSbF₆, LiTaF₆, and LiNbF₆.

4. The electrolyte of claim 3, wherein the Li salt is a blend that further includes at least one member of the group consisting of lithium trifluoromethane sulfonate (LiCF₃SO₃), lithium trifluorosulfonyl methane (LiTFSM), lithium trifluoroacetate (LiTFA), and lithium bis(fluorosulfonyl)imide (LiFSI).

5. The electrolyte of claim 1, wherein the fluorinated solvent includes at least one member of the group consisting of 2,2,2-trifluoroethyl butyrate, 2,2,2-trifluoroethyl propionate, bis(2,2,2-trifluoroethyl) ether, 1,1,2,2-tetrafluoroethyl-2,2,3,3-tetrafluoropropyl ether, 1,1,2,2-tetrafluoroethyl 2,2,2-trifluoroethyl ether, ethyl-1,1,2,2-tetrafluoroethyl ether, 2,2,2-trifluoroethyl 1,1,2,2-tetrafluoroethyl ether, ethyl 1,1,2,2-tetrafluoroethyl ether, propyl 1,1,2,2-tetrafluoroethyl ether, fluoromethyl 1,1,1,3,3,3-hexafluoroisopropyl ether, ethyl 1,1,2,3,3,3-hexafluoropropyl ether, hexafluoroisopropyl methyl ether, methyl 1,1,2,2-tetrafluoroethyl ether, 1,1,2,3,3,3-hexafluoropropyl methyl ether, 1,1,2,2-tetrafluoroethyl 2,2,2-trifluoroethyl ether, ethyl 1,1,1,2,2,3,4,5,5,5-decafluoro-3-methoxy-4-(trifluoromethyl)pentane, difluoromethyl 2,2,3,3-tetrafluoropropyl ether, methyl nonafluorobutyl ether, ethyl nonafluorobutyl ether, 1H,1H,5H-octafluoropentyl 1,1,2,2-tetrafluoroethyl ether, 1,1,1,3,3,3-hexafluoro-2-methoxypropane, 1,1,1,3,3,3-hexafluoro-2-(fluoromethoxy)propane, bis(2,2,2-trifluoroethoxy)methane, bis((1,1,1,3,3,3-hexafluoropropan-2-yl)oxy)methane, 2,2,2-trifluoroethyl acetate, 1,1,1,3,3,3-hexafluoropropan-2-yl acetate, methyl (2,2,2-trifluoroethyl) carbonate, 1,1,1,3,3,3-hexafluoropropan-2-yl methyl carbonate, tris(2,2,2-trifluoroethyl) phosphate, tris(1,1,1,3,3,3-hexafluoropropan-2-yl) phosphate, tris(2,2,2-trifluoroethyl) phosphite, and bis(2,2,2-trifluoroethyl) sulfite.

6. The electrolyte of claim 1, wherein the lithium polysulfide has the chemical formula: Li₂Sₓ, wherein x is in a range of from 1 to 8.

7. The electrolyte of claim 1, wherein the lithium polysulfide has a concentration of 0 M to 8 M.

8. The electrolyte of claim 1, wherein the Li salt has a concentration of 0.1 M to 10 M.

9. The electrolyte of claim 1, wherein the lithium nitrate has a concentration of 0.01 M to 10 M.

10. The electrolyte of claim 1, wherein the fluorinated solvent is 0% to 100% by volume.

11. A lithium-sulfur electrochemical device, comprising:
a) a cathode;
b) an anode;
c) a separator between the cathode and the anode; and
d) at least one of a liquid electrolyte and a polymer gel electrolyte in fluid communication with the cathode, the anode, and the separator, the electrolyte including:
i) a lithium (Li) salt,
ii) a fluorinated solvent,
iii) 1,3-dioxolane (DOL) solvent,
iv) 1,2-dimethoxyethane (DME) solvent,
v) lithium polysulfide (LiPS), and
vi) lithium nitrate (LiNO₃).

12. The lithium-sulfur electrochemical device of claim 11, wherein the electrochemical device is an electrochemical cell.

13. The lithium-sulfur electrochemical device of claim 12, wherein the electrochemical device is a lithium-sulfur battery.

14. The lithium-sulfur electrochemical device of claim 13, wherein the lithium-sulfur battery is a rechargeable lithium-sulfur battery.

15. The lithium-sulfur electrochemical device of claim 14, wherein the anode is selected from the group consisting of a silicon anode, a graphitic anode, a lithium metal anode, and a lithium alloy metal anode.

16. The lithium-sulfur electrochemical device of claim 15, wherein at least one of the anode, the cathode, and the separator is coated with an MXene-polymer composite material that includes a MXene component and a polymer component.

17. The lithium-sulfur electrochemical device of claim 16, wherein the MXene polymer composite material is at least one of a multilayer film and a blend of MXene and polymer components of the MXene polymer composite material.

18. The lithium-sulfur electrochemical device of claim 17, wherein the MXene-polymer composite material is a multilayer film.

19. The lithium-sulfur electrochemical device of claim 18, wherein the MXene-polymer composite material is a blend of the MXene and polymer components of the MXene polymer composite material.
